(19) United States
(12) Patent Application Publication
(10) Pub. No.: US 2023/0149937 A1
(43) Pub. Date: May 18, 2023

(54) AN ARM LINER FOR A CONE CRUSHER BOTTOM SHELL ASSEMBLY

(71) Applicant: SANDVIK SRP AB, Svedala (SE)

(72) Inventor: Johan GUNNARSSON, Sovde (SE)

(21) Appl. No.: 17/917,362

(22) PCT Filed: Apr. 9, 2020
(86) PCT No.: PCT/EP2020/060210

§ 371 Date: Oct. 6, 2022

(51) Int. Cl. B02C 2/00

(52) U.S. Cl. CPC B02C 2/005; B02C 2210/02

(57) ABSTRACT

A cone crusher bottom shell assembly has a bottom shell wall. An arm liner of the bottom shell assembly includes a central hub positioned radially within the bottom shell wall, a central cavity supporting a central crusher shaft, a material discharge chamber between the bottom shell wall and central hub through which crushed material falls, and a plurality of support arms extending radially between the bottom shell wall and the central hub. The arm liner has a radially outer flange section configured in use to extend over part of an inner surface of the bottom shell wall, a radially inner section configured in use to abut an outer surface of the central hub, and a saddle section configured in use to cover a support arm and having an upper surface capable of contacting material falling through the discharge chamber, wherein the upper surface has a radially extending wear bar.

### FIELD OF THE INVENTION

The present invention relates to an arm liner for a cone crusher bottom shell assembly, a bottom shell assembly for a cone crusher, and a cone crusher.

### BACKGROUND TO THE INVENTION

Cone (or gyratory) crushers are used for crushing and size reducing hard materials such as ore, mineral and rock. The crusher generally includes a top shell assembly, a central crusher shaft for operation of the top shell assembly, a bottom shell assembly, and a frame. The top shell assembly comprises a crushing head mounted to an upper end of the central crusher shaft, an inner crushing shell (referred to as an inner shell or mantle) mounted to the crushing head, and a second crushing shell (referred to as an outer shell or concave) mounted to a frame so that a crushing chamber is defined between the inner shell and outer shell. A drive mechanism is operatively connected to the central crusher shaft for rotation of the inner shell within the outer shell about an eccentric (gyratory) axis to crush material passed into the crushing chamber. Examples of cone crushers and inner shells for cone crushers are described in EP2818246, EP2774680 and EP1868726.

The main purpose of the bottom shell assembly is to support the drive shaft and provide a material discharge chamber disposed underneath the crushing chamber through which material crushed in the crushing chamber falls before being ejected from the cone crusher. To this end, the bottom shell assembly comprises bottom shell wall, a central hub positioned radially within the bottom shell wall and having a central cavity to support a central crusher shaft, a material discharge chamber defined between the bottom shell wall and central hub through which crushed material falls, and a plurality of support arms extending radially between the bottom shell wall and the central hub. As the support arms project radially across the material discharge chamber, the top surfaces of the support arms will continually come into contact with the falling crushed material, and therefore are prone to extensive wear. To prevent this problem, arm liners are provided that cover the top surface of the support arms that help prevent damage to the support arms. A bottom shell assembly for a cone crusher is described in WO2015051989. However, despite the use of arm liners, support arms get damaged during use and tend to have a short lifespan.

It is an object of the invention to overcome at least one of the above-referenced problems.

### SUMMARY OF THE INVENTION

In a first aspect, the invention provides an arm liner for a cone crusher bottom shell assembly of the type having a bottom shell wall, a central hub positioned radially within the bottom shell wall and having a central cavity to support a central crusher shaft, a material discharge chamber defined between the bottom shell wall and central hub through which crushed material falls, and a plurality of support arms extending radially between the bottom shell wall and the central hub, the arm liner comprising:
a radially outer flange section configured in use to extend over a region of an inner surface of the bottom shell wall;
a radially inner section configured in use to abut an outer surface of the central hub, and
a saddle section configured in use to cover a support arm and having an upper surface capable of contacting material falling through the discharge chamber, characterised in that the upper surface of the saddle section comprises a radially extending wear bar disposed on the upper surface.

The provision of a radially extending wear bar on the arm liner helps protect selected areas of the arm liner from wear. The wear bar comprises a localised area pm the upper surface of the arm liner that comprises a material that has a hardness greater than the material of the arm liner. Thus, when the arm liner is formed from steel or manganese steel, the wear bar may be formed from a wear resistant material such as cement carbide, for example titanium carboide or boron carbide. It will be appreciated that the arm liner can be positioned on different parts of the surface of the arm liner, to protect selected area of the arm liner surface that are most prone to wear. This will vary according to the material being crushed, the type of crushing operation and the design of the support arms. Moreover, as described below, the arm liner can be incorporated into the arm liner, or mounted on top of the arm liner providing a baffle configured to defect material away from the arm liner, or be provided as a localised area that is cast in-situ.

In any embodiment, the arm liner comprises a radially extending wear bar disposed on each side of the upper surface. This configuration has been found to be particularly effective in many cone crushers, as the areas of highest wear tends to be on the slanted sides of the arm liners.

In any embodiment, the radially extending wear bars are symmetrically disposed on each side of the upper surface.

In any embodiment, the radially extending wear bars are positioned on the upper surface of the arm liner such that when viewed from above the wear bars are disposed on a radial periphery of the arm liner. This is best viewed in FIG. 1 where the arm liners positioned at six, nine and twelve o'clock in the bottom shell assembly each has two arm liners which cover the radial periphery of the arm liner when viewed from above. In the embodiment shown, the arm liners extend along a full periphery of the saddle section of the arm liner but it will be appreciated that the arm liners may only extend along a part of the periphery.

It will be appreciated that the arm liner may comprise more than two wear bars, depending on the pattern of wear that the arm liner is subjected to. For example, in one embodiment, the arm liner may include three radially extending wear bars including a central radially extending wear bars and a radially extending wear bar disposed on each side of the central wear bar. In another embodiment, the arm liner may have a single radially extending wear bar, which may have sufficient width to cover most or all of a top surface of the arm liner.

In any embodiment, the or each radially extending wear bar extends proud of the upper surface of the saddle section to create a baffle to deflect falling material away from the arm liner during use. This configuration has been found to be particularly useful in preventing wear, as the raised wear bar acts as a baffle that functions during sue to deflect falling material away from the arm liner.

In any embodiment, the or each radially extending wear bar extends from the radially inner section to the radially outer flange section. This configuration ensures that the wear bars protect the areas of the arm liner that are prone to wear.

In any embodiment, the arm liner has a curved profile dimensioned to conform to an upper half of a support arm.

In any embodiment, each side of the saddle section has an upper curved section and a lower skirt section, in which each radially extending wear bars is mounted on the upper curved section. This configuration has been found to be particularly effective in many cone crushers, as the areas of highest wear tends to be on the slanted sides of the arm liners.

In any embodiment, the or each radially extending wear bar comprises a plurality of wear tiles.

In any embodiment, the or each radially extending wear bar comprises any one or a combination of cement carbide, aluminium oxide, zirconium oxide, silicon carbide, boron carbide, silicon nitride, titanium carbide or boron nitride.

In any embodiment, the radially extending wear bars are detachably mountable to the arm liner. This allows the use of modular wear bars that can be replaced due to wear or replaced with wear bars that are designed for a specific application.

In any embodiment, the or each radially extending wear bar has an elongated shape and is typically contoured to match the contoured upper surface of the saddle section of the wear bar.

In any embodiment, the saddle section comprises a flared transition section providing a smooth curving transition into the radially outer flange section.

In any embodiment, the or each radially extending wear bar comprises or consists essentially of steel, preferably manganese steel.

In any embodiment, the or each radially extending wear bar comprises or consists essentially cement carbide.

In any embodiment, the radially inner section comprises an extension collar configured in use to extend over an upper section of the outer surface of the central hub surrounding the support arm and to prevent falling material impacting the outer surface of the central hub. This has been found to help protect the radially outward facing surface of the central hub from wear due to material impacting the surface, including falling material and material that has deflected off the arm liner.

In any embodiment, the extension collar extends circumferentially around the radially inner section between inner ends of the radially extending wear bars. This configuration has been found to provide optimum protection to the central hub.

In any embodiment, the or each radially extending wear bar extends proud of the upper surface of the saddle section by a height of at least 30 mm above the upper surface up to a height corresponding to a top of the extension collar. Thus, in one embodiment, the or each radially extending wear bar extends proud of the upper surface of the saddle section by a height of at least 30 mm to 110 mm, for example 30-50 mm, 50-70 mm, 70-90 mm or 90-110 mm, above the upper surface. The height of the extension collar may be varied according to the design of the bottom shell assembly, the material being crushed, and the crushing operation.

In any embodiment, the arm liner is configured for detachable attachment to the bottom shell assembly. This allows the use of modular arm liners that can be replaced periodically.

In another aspect, the invention provides a cone crusher bottom shell assembly comprising:
a bottom shell wall extending circumferentially around a central axis;
a central hub extending circumferentially around the central axis radially within the bottom shell wall and having a central cavity to support a central crusher shaft;
a material discharge chamber defined between the bottom shell wall and central hub through which crushed material falls during use;
a plurality of support arms extending radially between the bottom shell wall and the central hub; and
an arm liner according to the invention covering at least one of the support arms.

In any embodiment, the cone crusher bottom shell assembly comprises a plurality of arm liners according to the invention covering the plurality of the support arms.

In any embodiment, an inner surface of the bottom shell wall is lined fully or partially with a wear resistant liner. Such wear resistant liners are described in WO2014072136.

In another aspect, the invention provides a cone crusher comprising a top shell assembly having an inner shell and an outer shell, and a bottom shell assembly according to the invention coupled to the top shell or configured for coupling to the top shell.

Other aspects and preferred embodiments of the invention are defined and described in the other claims set out below.

### BRIEF DESCRIPTION OF THE FIGURES

FIG. 1 is a plan view from above of a cone crusher bottom assembly having four arm liners according to the invention, each covering a top of a support arm of the bottom assembly.

FIG. 2 is an end, partially perspective, view of an arm liner according to the invention showing with the radially inner section in the foreground and the radially outer flange section in the background.

FIG. 3 is a side elevational view of the arm liner of FIG. 2.

FIG. 4 is a sectional view of the bottom assembly of FIG. 1 taken along the section line II-II of FIG. 1.

### DETAILED DESCRIPTION OF THE INVENTION

All publications, patents, patent applications and other references mentioned herein are hereby incorporated by reference in their entireties for all purposes as if each individual publication, patent or patent application were specifically and individually indicated to be incorporated by reference and the content thereof recited in full.

### Definitions and General Preferences

Where used herein and unless specifically indicated otherwise, the following terms are intended to have the following meanings in addition to any broader (or narrower) meanings the terms might enjoy in the art:

Unless otherwise required by context, the use herein of the singular is to be read to include the plural and vice versa. The term “a” or “an” used in relation to an entity is to be read to refer to one or more of that entity. As such, the terms “a” (or “an”), “one or more,” and “at least one” are used interchangeably herein.

As used herein, the term “comprise,” or variations thereof such as “comprises” or “comprising,” are to be read to indicate the inclusion of any recited integer (e.g. a feature, element, characteristic, property, method/process step or limitation) or group of integers (e.g. features, element, characteristics, properties, method/process steps or limitations) but not the exclusion of any other integer or group of integers. Thus, as used herein the term “comprising” is inclusive or open-ended and does not exclude additional, unrecited integers or method/process steps.

### Exemplification

The invention will now be described with reference to specific Examples. These are merely exemplary and for illustrative purposes only: they are not intended to be limiting in any way to the scope of the monopoly claimed or to the invention described. These examples constitute the best mode currently contemplated for practicing the invention.

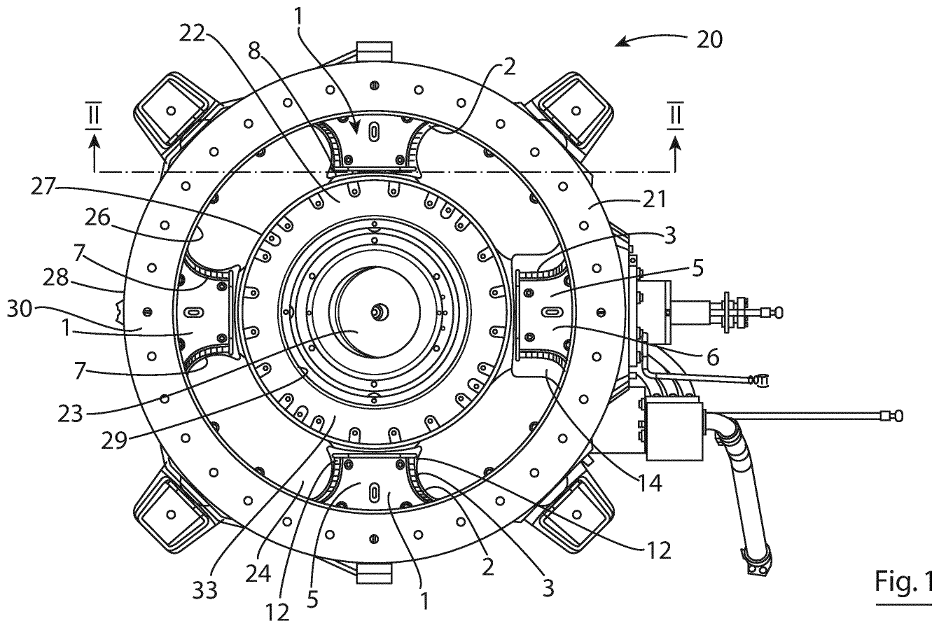

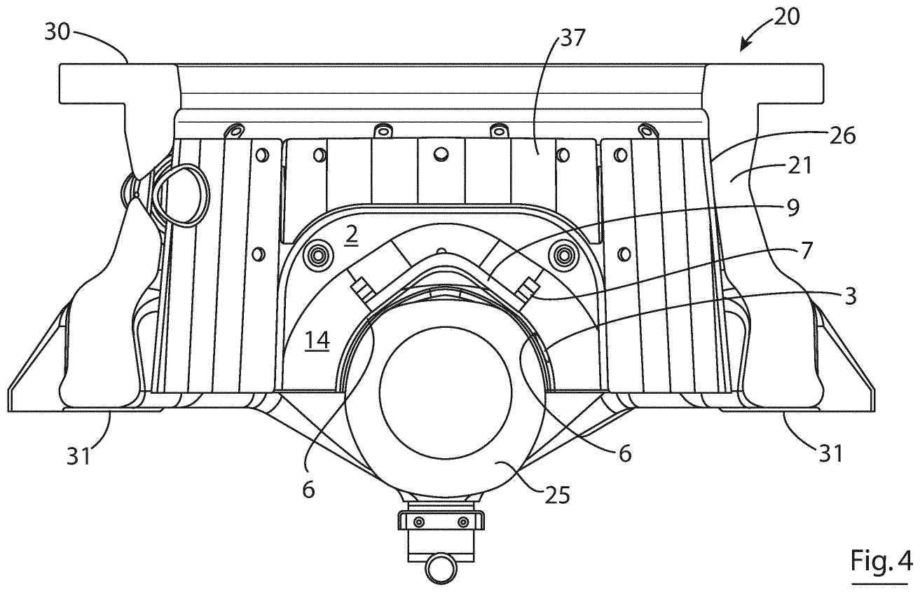

Referring to the Figures, and initially to FIGS. 1 and 4, a bottom shell assembly for a cone crusher, indicated generally by the reference numeral 20, is illustrated. The bottom shell assembly 20 comprises a bottom shell wall 21 arranged about a central axis having a radially inner facing surface 26 covered with wear resistant liner tiles 37 and a radially outer facing surface 28. Outer shell wall 21 is terminated at an axial upper end by an annular rim having an annular upward facing planar surface 30. A corresponding axial lower end of the outer shell wall 21 is terminated by a lower rim 31 for mounting against a base or lower support structure (not shown).

The bottom shell assembly 20 includes an annular central hub 22 positioned radially within the bottom shell wall and having a central cavity 23 positioned radially within the central hub 22 to support a central crusher shaft (not shown). The central hub has a radially outward facing surface 27 and a radially inward facing surface 29, and is terminated at an axial upper end by an annular rim having an annular upward facing planar surface 33 and at an axial lower by a lower rim (not shown). The central hub 22 has a height that is less than that of the bottom shell wall, with the result that the annular rim surface 33 of the central hub is positioned lower than the annular rim surface 30 of the bottom shell wall 21.

A material discharge chamber 24 is defined between the bottom shell wall 21 and central hub 22. When the bottom shell assembly 20 is coupled to a top shell assembly, the material discharge chamber is aligned with the crushing chamber of the top shell assembly so that it received crushed material which falls through the material discharge chamber before be discharged from the cone crusher.

The central hub 22 is supported radially within the bottom shell wall 21 by support arms 25 that extend radially between the radially inner facing surface 26 of the bottom shell wall 21 and the radially outward facing surface 27 of the central hub 22. In this case, the bottom shell assembly 20 has four support arms 25 that are equally spaced around the circumference of the radially inner facing surface 26 of the bottom shell wall 21. It will be appreciated that the invention also covers a bottom shell assembly that has more or less than four support arms. Although not clearly shown in the figures, the support arms are generally cylindrical with an inner end mounted to the radially inwardly facing surface of the central hub and an outer end terminating in a flared part that is mounted to the radially inward facing surface of the outer shell wall. As the support arms project radially across the material discharge chamber, the top surfaces of the support arms will continually come into contact with the falling crushed material, and therefore are prone to extensive wear.

The bottom shell assembly also includes an arm liner 1 for covering and protecting each of the four the support arms 25. FIG. 1 shows the four arm liners 1 mounted between the shell wall 21 and the central hub 22 and covering the supports arms (not shown), and FIG. 4 is a sectional view showing how the arm liner 1 covers the upper surface of the support arm 25 and is dimensioned to closely adhere to the surface of the support arm. In this case the arm liners are formed from manganese steel, although other types of metal alloys may be employed to make the arm liner.

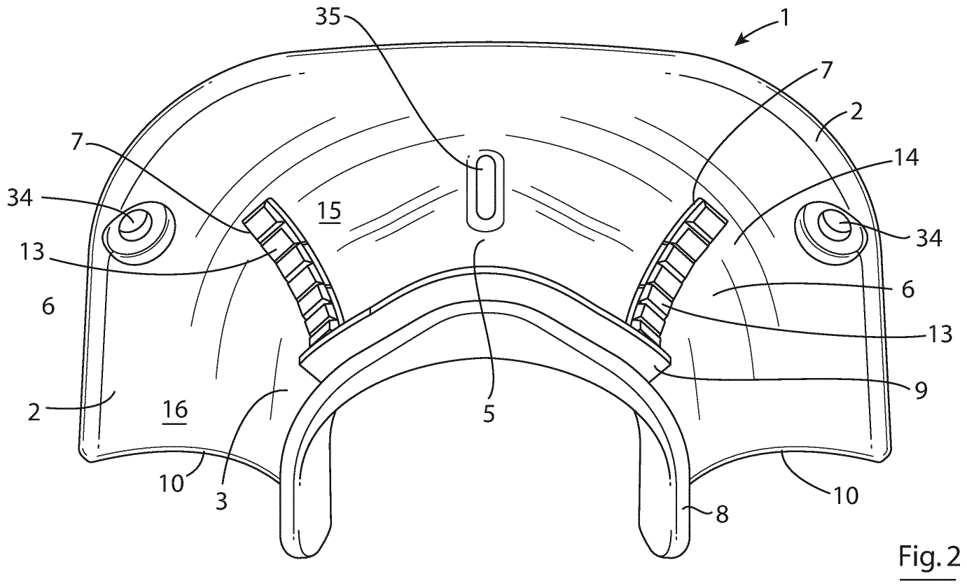

Referring to FIG. 2, one of arm liners 1 of FIG. 1 is described in more detail in which parts described with reference to the previous embodiments of the invention are assigned the same reference numerals. FIG. 2 is an end view of the arm liner 1 with the radially inner section in the foreground and the radially outer flange section in the background. The arm liner comprises a radially outer flange section 2 configured in use to extend over a region of the inner surface 26 of the bottom shell wall 21, and a radially inner section 8 configured in use to abut an outer surface 27 of the central hub 22, and a saddle section 3 configured in use to cover a support arm 25 and having an upper surface 4 capable of contacting material falling through the discharge chamber 24. The radially outer flange section 2 has a diameter at its widest dimension that is at least two times the diameter across the radially inner section 8. In the embodiment illustrated, the saddle section is quite a short section, but it will be appreciated that it may be longer depending on the design of the bottom shell assembly and in particular the radial distance between the outer shell wall 21 and the central hub 22.

In the embodiment shown, the saddle section 3 has a half-pipe type configuration with a curved profile dimensioned to cover and closely adhere to the top of the support arm 25, and thereby protect the support arm 25 from falling crushed material, including a central axially uppermost section 5 and side sections 6 that curve downwardly away from the central section 5. Each side section 6 comprises an upper curved section 15 and a lower skirt section 16 terminating at lower edge 10. The radially inward part of the saddle section 3 comprises a flared transition section 14 providing a smooth curving transition into the radially outer flange section 2.

Each side of the radially outer flange section 2 of the arm liner 1 includes countersunk attachment bores 34 that are used for receiving fixing bolts for the purpose of securing the arm liner to the bottom shell wall 21. In addition, the central uppermost section of the saddle section 3 includes a slotted hole 35 configured for receipt of a lifting attachment (not shown). The arm liner 1 may be configured to be coupled to the bottom shell assembly so that it is supported at one or both ends, and optionally supported by at least part of the saddle section 3 resting on the support arm 25. In one embodiment, the saddle section does not bear against the support arm.

Two radially extending wear bars 7 are provided on the arm liner 1, symmetrically disposed on each side of the central uppermost section 5 and extending radially along the length of the saddle section including the flared transition section 14. In the embodiment shown, the wear bars 7 are positioned on the upper curved section 15 of the side section, midway between the central uppermost section 5 and the lower end 10 of the skirt section 16. It will be appreciated that the radially extending wear bars may be positioned elsewhere on the upper surface of the saddle section 3, depending on the type of material being crushed. The wear bars 7 have an elongated shape and comprise a series of adjacent wear tiles 13 formed of cement carbide. The wear bars 7 are mounted on the upper surface 4 of the saddle section by suitable fixing means (such as screws) and project proud of the surface by a distance of about 30 mm along their length. This in effect provides a baffle on each side of the saddle section which has been found to deflect falling material away from the arm liner during use, and thereby increase the protection afforded to the support arm during use. The height of the wear bars may be varied to change their baffle properties according to the material being crushed and maximise protection to the support arm. For example, the height about the upper surface of the saddle section may be varied from, for example, 30 mm up to 110 mm or greater.

In this embodiment, the arm liner is formed from a cement carbide, for example a titanium carbide, although other wear resistant material may be employed, for example aluminium oxide, zirconium oxide, silicon carbide, boron carbide, silicon nitride, titanium carbide or boron nitride.

In one embodiment, the wear bars may be mounted in the surface of the saddle section and have a top surface that is flush with the upper surface of the saddle section. Also, the wear bars may be integrally formed with the saddle section, using wear material inserts that are cast in-situ during the casting of the arm liner. Methods for in-situ casting of local wear regions in crusher parts is described in the literature, including US2011/303778 and WO2017/081665.

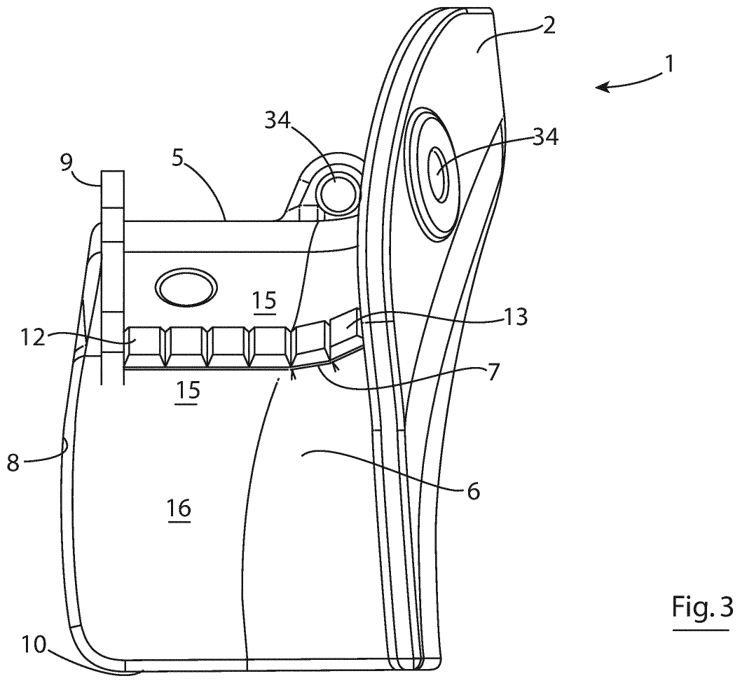

Referring to FIGS. 2 and 3, the arm liner 1 comprises an extension collar 9 that is mounted to a radially inner section 8 of the saddle section 3 and configured in use to extend over an upper section of the outer surface 27 of the central hub 22 surrounding the support arm 25 and to prevent falling material impacting the outer surface 27 of the central hub 22. The extension collar 9 comprises a flat elongated piece of steel that is contoured along its length to match the curved upper surface of the saddle section 3 and has a length that is sufficient to allow it extend circumferentially around the radially inner section 8 between inner ends 12 of the radially extending wear bars 7. The height of the extension collar 9 may vary between 30 mm up to about 110 mm depending on the type of material being crushed and the crushing process parameters. The extension collar is generally attached to the radially inner section 8 of the saddle section 3 by screws and is usually formed of manganese steel although it may also be formed of a wear material such as a cement carbide.

The arm liners of the invention are configured for detachable mounting to the bottom shell assembly and can therefore be removed once they are worn and replaced with replacement arm liners. Thus, in one embodiment of the invention, the invention provides a bottom shell assembly, or a cone crusher, comprising one or more replacement arm liners according to the invention.

It will be appreciated that the wear bar forming part of the arm liner of the invention may be integrally formed with the arm liner, or may be detachably attached to the arm liner. The latter configuration is advantageous insofar as it allows modular wear bars to be employed, allowing wear bars to be replaced without the requirement to replace an arm liner.

### EQUIVALENTS

The foregoing description details presently preferred embodiments of the present invention. Numerous modifications and variations in practice thereof are expected to occur to those skilled in the art upon consideration of these descriptions. Those modifications and variations are intended to be encompassed within the claims appended hereto.

1. An arm liner for a cone crusher bottom shell assembly having a bottom shell wall, a central hub positioned radially within the bottom shell wall and a central cavity arranged to support a central crusher shaft, a material discharge chamber defined between the bottom shell wall and central hub through which crushed material falls, and a plurality of support arms extending radially between the bottom shell wall and the central hub, the arm liner comprising:
a radially outer flange section configured in use to extend over a region of an inner surface of the bottom shell wall;
a radially inner section configured in use to abut an outer surface of the central hub; and
a saddle section configured in use to cover a support arm and having an upper surface capable of contacting material falling through the discharge chamber, wherein the upper surface of the saddle section includes a radially extending wear bar disposed on the upper surface.

2. The arm liner according to claim 1, further comprising a radially extending wear bar disposed on each side of the upper surface.

3. The arm liner according to claim 1, wherein the radially extending wear bars are symmetrically disposed on each side of the upper surface.

4. The arm liner according to claim 1, wherein each radially extending wear bar extends proud of the upper surface of the saddle section to form a baffle to deflect falling material away from the arm liner during use.

5. The arm liner according to claim 1, wherein each radially extending wear bar extends from the radially inner section to the radially outer flange section.

6. The arm liner according to claim 1, comprising a curved profile dimensioned to conform to an upper half of a support arm.

7. The arm liner according to claim 1, wherein each side of the saddle section has an upper curved section and a lower skirt section, in which each radially extending wear bars is mounted on the upper curved section.

8. The arm liner according to claim 1, wherein the radially extending wear bar includes a plurality of wear tiles.

9. The arm liner according to claim 1, wherein the wear bars include any one or a combination of cement carbide, aluminium oxide, zirconium oxide, silicon carbide, boron carbide, silicon nitride, titanium carbide or boron nitride.

10. The arm liner according to claim 1, wherein the saddle section includes a flared transition section providing a smooth curving transition into the radially outer flange section.

11. The arm liner according to claim 1, the arm liner being formed of manganese steel in which the radially extending wear bars are formed of cement carbide.

12. The arm liner according to claim 1, wherein the radially inner section includes an extension collar configured in use to extend over an upper section of the outer surface of the central hub surrounding the support arm and to prevent falling material from impacting the outer surface of the central hub.

13. The arm liner according to claim 12, wherein the extension collar extends circumferentially around the radially inner section between inner ends of the radially extending wear bars.

14. The arm liner according to claim 12, wherein each radially extending wear bar extends proud of the upper surface of the saddle section by a height of at least 30 mm above the upper surface up to a height corresponding to a top of the extension collar.

15. A cone crusher bottom shell assembly comprising:
a bottom shell wall extending circumferentially around a central axis;
a central hub extending circumferentially around the central axis radially within the bottom shell wall and having a central cavity to support a central crusher shaft;
a material discharge chamber defined between the bottom shell wall and central hub through which crushed material falls during use;
a plurality of support arms extending radially between the bottom shell wall and the central hub; and
an arm liner according to claim 1 covering at least one of the support arms.

16. A cone crusher comprising:
a top shell assembly having an inner shell, an outer shell, and a bottom shell assembly according to claim 15 coupled to the top shell.
